(19) United States
(12) Patent Application Publication
(10) Pub. No.: US 2010/0201105 A1
(43) Pub. Date: Aug. 12, 2010

(54) Airbag cover and airbag apparatus

(75) Inventor: Masaru Iwazato, Minato-ku (JP)

Correspondence Address: FOLEY AND LARDNER LLP;SUITE 500, 3000 K STREET NW, WASHINGTON, DC, 20007, US

(73) Assignee: Takata Corporation

(21) Appl. No.: 12/656,065

(22) Filed: Jan. 14, 2010

(30) Foreign Application Priority Data
Feb. 6, 2009 (JP) 2009-026069

(51) Int. Cl. B60R 21/20; B60R 21/16

(52) U.S. Cl. 280/728.3; 280/731

(57) ABSTRACT

An airbag apparatus includes an airbag that is normally in a folded state and inflates and deploys in the event of an emergency, an inflator that supplies gas to the airbag, a retainer that houses the airbag, and an airbag cover that normally conceals the airbag and, in the event of an emergency, causes the door portions to thereof to split open for releasing the airbag into the passenger compartment, wherein the airbag has a vent hole that can release gas supplied to the inside thereof, and the vent hole is disposed along a side surface portion of the airbag cover, and the door portion is configured so as not to rotate to the side of the side surface portion.

### BACKGROUND

The present application relates to airbag covers and airbag apparatuses mounted on vehicles such as automobiles, and more specifically, it relates to an airbag cover and an airbag apparatus characterized by means for splitting open an airbag cover.

Vehicles such as automobiles are typically provided with an airbag apparatus that inflates and deploys an airbag for absorbing an impact exerted on an occupant in the passenger compartment in the event of a collision or abrupt deceleration. Many types of airbag apparatuses have been developed and provided as such an airbag apparatus, which includes a driver side airbag apparatus provided inside a steering wheel, a passenger side airbag apparatus provided inside an instrument panel, a side airbag apparatus provided inside the side of the vehicle or the vehicle seat, a curtain airbag apparatus provided inside the upper part of the door, a knee airbag apparatus provided so as to protect the knee of the occupant, and a pedestrian protective airbag apparatus provided under the hood of the vehicle and the like. These airbag apparatuses typically have an airbag that is normally in a folded state and inflates and deploys in the event of an emergency, an inflator that supplies gas to the airbag, a retainer that houses the airbag, and an airbag cover that normally conceals the airbag and, in the event of an emergency, splits open a door portion thereof for releasing the airbag into the passenger compartment.

The airbag cover is a resin-molded, thin-walled plate-like component having a groove called a tear line formed on the back face thereof. Such a tear line consists of a groove formed to be thin-walled for allowing the airbag to easily split open the airbag cover. A door portion formed by splitting open the airbag cover is rotatably supported by a hinge portion, a portion connecting with the airbag cover, forming a release section through which the airbag is.

It would be advantageous to provide an airbag cover and an airbag apparatus which can enhance the flexibility in design of a vent hole to be formed in an airbag.

### SUMMARY

One disclosed embodiment relates to an airbag cover that normally conceals an airbag and, in the event of an emergency, splits open a door portion thereof for releasing the airbag. The airbag has a vent hole that can release gas supplied to an inside thereof. The vent hole is disposed along a side surface portion of the airbag cover. The door portion is configured so as not to rotate to the side of the side surface portion.

Another disclosed embodiment relates to an airbag apparatus comprising an airbag that is normally in a folded state and inflates and deploys in the event of an emergency, an inflator that supplies gas to the airbag, a retainer that houses the airbag, and an airbag cover that normally conceals the airbag. In the event of an emergency, the airbag cover splits open a door portion thereof for releasing the airbag into a passenger compartment. The airbag has a vent hole that can release gas supplied to an inside thereof. The vent hole is disposed along a side surface portion of the airbag cover. The door portion is configured so as not to rotate to the side of the side surface portion.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1(A) is a front view showing an airbag apparatus according to an exemplary embodiment.

FIG. 1(B) is a sectional view of the airbag apparatus of FIG. 1(A) taken along the line B-B according to an exemplary embodiment.

FIG. 2(A) is a front view of an airbag as inflated and deployed showing the effect of an airbag apparatus according to an exemplary embodiment.

FIG. 2(B) is a rear view of an airbag as inflated and deployed showing the effect of an airbag apparatus according to an exemplary embodiment.

FIGS. 3 (A)-3(C) are sectional views showing a modification to an airbag apparatus according to several exemplary embodiments.

FIGS. 4 (A)-4(D) are front views showing modifications to an airbag apparatus according to several exemplary embodiments.

FIG. 5(A) is a front view of an airbag apparatus according to another exemplary embodiment.

FIG. 5(B) is a front view of the airbag of FIG. 5(A) as inflated and deployed according to another exemplary embodiment.

FIG. 5(C) is a rear view of the airbag of FIG. 5(A) as inflated and deployed according to another exemplary embodiment.

### DETAILED DESCRIPTION

An airbag cover described in Japanese Patent No. 4032544 (incorporated by reference herein) is configured so as to split open in a substantially H-shape and is also configured in such a manner that, when the door portion is divided into two portions, these door portions rotate upward and downward, respectively. Also, an airbag cover described in Japanese Patent No. 3478974 (incorporated by reference herein) is configured so as to split open in a substantially mountain shape and is also configured in such a manner that, when the door portion is divided into three portions, these door portions rotate in the upper left direction, in the upper right direction, and in the downward direction, respectively.

An airbag may have an exhaust port called a vent hole formed therein. Such a vent hole has a function of preventing the inside pressure of airbags from rising to an excessively high level or, when an occupant comes into contact with an inflated airbag, mitigating an impact on the occupant by releasing the gas inside of the airbag. The conditions for forming the vent hole, such as the location, size, quantity and the like, are determined by the airbag size, capacity, mounting position, vehicle type and the like. For example, a driver side airbag disclosed in Japanese Patent No. 4032544 and Japanese Patent No. 3478974 may have a vent hole formed in a space created between the upper side portion of the airbag cover and the steering wheel.

However, an airbag cover described in Japanese Patent No. 4032544 and Japanese Patent No. 3478974 described above encounters a problem that rotatable door portions provided at the upper side portion thereof narrow a space formed between the upper side portion and the steering wheel, which restricts the flexibility in design of the vent hole to be formed in an airbag. Such a problem is not limited to driver side airbags, and is a common problem encountered when an attempt is made to form a vent hole around the airbag cover.

According to an exemplary embodiment, an airbag apparatus includes an airbag that is normally in a folded state and inflates and deploys in the event of an emergency. The apparatus further includes an inflator that supplies gas to the airbag, a retainer that houses the airbag, and an airbag cover that normally conceals the airbag. The airbag cover may be used as, for example, a driver side airbag cover that is disposed in the hub of the steering wheel.

In the event of an emergency, the airbag cover splits open a door portion thereof for releasing the airbag into the passenger compartment. The airbag has a vent hole that can release gas supplied to the inside thereof. The vent hole is disposed along a side surface of the airbag cover, and the door portion is configured so as not to rotate to the side of the side surface portion.

In the airbag apparatus described above, the airbag may have a wrapping component that normally retains the shape of the airbag. A predetermined fracture portion is on the wrapping component which, in the event of an emergency, fractures to allow the airbag to be released and deploy. The predetermined fracture portion may be disposed in the vicinity of a portion where the door portion begins to split open. The airbag may be folded in such a manner that the end of the airbag is disposed in the vicinity of a portion where the door portion begins to split open.

In the airbag cover and airbag apparatus described above, the door portion may be configured to open in the same manner as double doors along the side surface portion. The door portion may be configured to have an ornament to be disposed on the airbag cover surface provided thereon in such a manner that such an ornament rotates together with the door portion. Furthermore, the door portion may consist of a first door portion and a second door portion which are configured to open in the same manner as double doors along the side surface portion and a third door portion which is configured to be rotatable to the opposite side of the side surface portion. An ornament may be provided for the third door portion and may be disposed on the airbag cover surface.

The door portion for the airbag cover and the airbag apparatus described above is configured to not rotate to the side surface portion where a vent hole is disposed, thereby preventing the rotating door portion from blocking the vent hole even if the airbag inflates and deploys in the event of an emergency. This allows the vent hole to be disposed along the side surface portion of the airbag cover, thereby enhancing the flexibility in design of the vent hole to be formed in the airbag.

The use of double doors in the door portion allows the airbag cover to promptly, smoothly split open, thereby allowing the efficient inflation and deployment of the airbag. Causing an ornament such as an emblem or the like to be rotated together with the door portion allows a larger space inside the airbag cover, namely, a larger space for housing the airbag to be secured. Furthermore, placement of the ornament on the third door portion allows the first door portion and second door portion to be promptly, smoothly opened in the same manner as double doors while allowing the ornament to be rotated together with the third door portion. In addition, use of the airbag cover as a driver side airbag cover can provide advantages above more efficiently.

The airbag cover can be split open promptly, smoothly by adjusting the location of a predetermined fracture portion in the wrapping component or the method of folding the airbag, thereby allowing the airbag to be efficiently inflated and deployed.

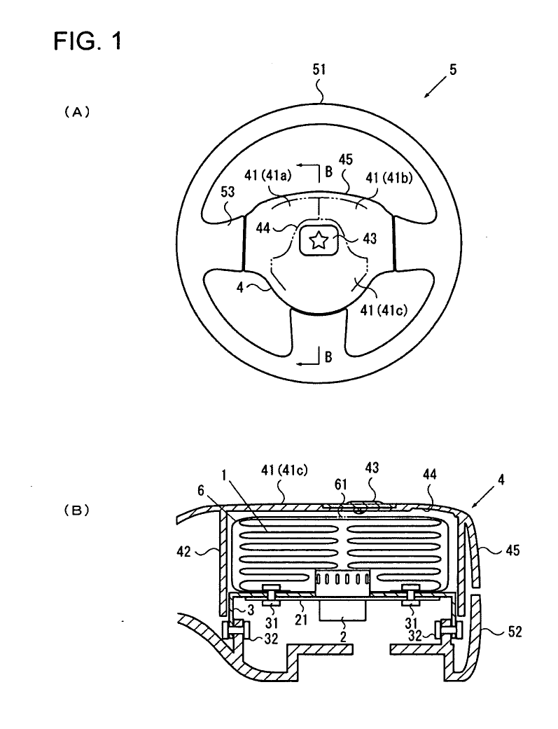

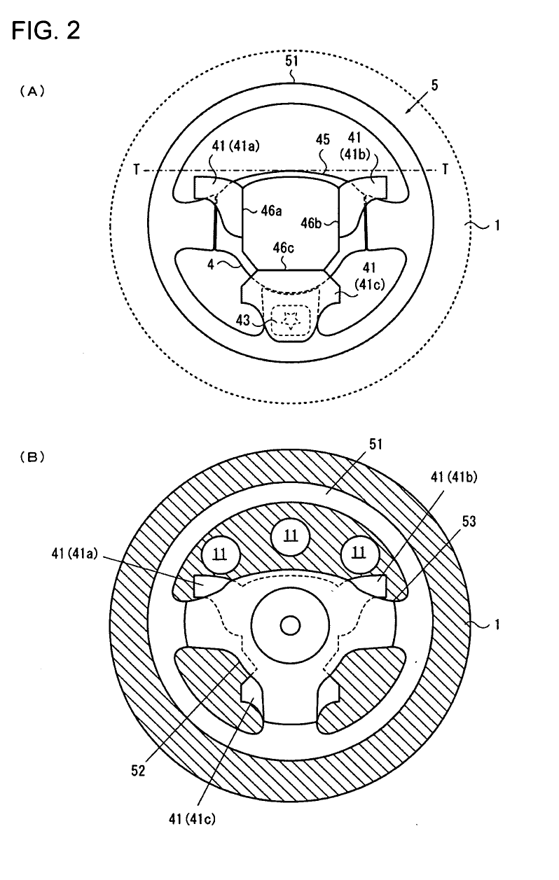

An airbag apparatus according to several exemplary embodiments will be described below in regards to FIGS. 1 to 5. An airbag apparatus, shown in FIG. 1 and FIG. 2, has an airbag 1 that is normally in a folded state and inflates and deploys in the event of an emergency, an inflator 2 that supplies gas to the airbag 1, a retainer 3 that houses the airbag 1, and an airbag cover 4 that normally conceals the airbag 1.

An airbag apparatus shown in FIG. 1 and FIG. 2 is a driver side airbag apparatus, which is disposed in a steering wheel 5. The steering wheel 5 includes an annular rim 51 constituting a handle portion, a hub 52 connected to a steering shaft, and a spoke 53 connecting the rim 51 to the hub 52. The steering wheel having three spokes 53 is shown. Diagrams showing the steering shaft and the steering column are omitted in FIG. 1(B). The airbag cover 4 is connected such that it covers the hub 52, in which the airbag 1, the inflator 2, and the retainer 3 are disposed.

As shown in FIG. 1(B), the airbag 1 is normally housed in a folded state in a space formed by the retainer 3 and the airbag cover 4. In the figure, the airbag 1 is inwardly folded. The airbag 1 is wrapped with a wrapping component 6 while housed in such a space, and the shape of the airbag 1 in a folded state is retained by the wrapping component 6. The wrapping component 6 has a predetermined fracture portion 61 formed therein, which, in the event of an emergency, fractures for allowing the airbag to be released. The wrapping component 6 may include a cloth-like or a strap-like component.

The inflator 2 has a substantially cylindrical outer shape and has gas jetting ports formed at a circumferential side surface of its end contained in the airbag 1. The inflator 2 is fit in an opening formed in the retainer 3 and is secured by a flange portion 21. Also, the inflator 2 is connected to an electronic control unit (ECU) (not illustrated) and is controlled on the basis of measurements obtained by an acceleration sensor or the like. In the event of an emergency in which the ECU detects or predicts a crash or abrupt deceleration of a vehicle, the inflator 2 is ignited by an ignition current from the ECU, causing an agent contained in the inflator 2 to combust and produce gas which is supplied to the airbag 1.

The retainer 3, which retains the airbag 1 and the inflator 2 in an integral manner, is a component for housing the airbag 1 in the airbag cover 4. The retainer 3 has an opening formed substantially in the center thereof, into which the inflator 2 is inserted. The retainer 3 has fasteners 31 such as bolts and nuts disposed thereon, which hold the flange portion 21 of the inflator 2 and the airbag 1 therebetween. The retainer 3 is secured to the hub 52 with fasteners 32 such as bolts and nuts disposed at the leg portion thereof. Although not illustrated, the retainer 3 may be secured by locking a plurality of hooks formed at the outer circumference of the retainer 3 into holes formed at leg portions 42 of the airbag cover 4.

The airbag cover 4, which is disposed in the hub 52, is a component for covering the hub 52 and the airbag 1. More specifically, the airbag cover 4 is formed in a substantially cup-like shape so as to be able to cover the hub 52, and has leg portion 42. The leg portions 42 stand upright on an inner circumferential surface of the airbag cover 4, creating a space for housing the airbag 1. Although not illustrated, when the airbag cover 4 is used as a horn switch, the airbag cover 4 is disposed so as to be slidable on the hub 52. According to an exemplary embodiment, the airbag cover 4 is also a component of the vehicle interior surface and, therefore, an ornament 43 such as an emblem may be provided on the front face of the airbag cover 4.

A thin-wall tear line 44 is formed at the back face of the cover 4 in a predetermined shape. The cover 4 is relatively low in strength proximate to the thin-wall tear line 44 and splits open along the thin-wall tear line 44 into the door portion 41 (the first door portion 41a, the second door portion 41b, and the third door portion 41c). As shown in FIG. 1(A), the tear line 44 is formed, for example, in a combined shape of a substantially T shape and a substantially inverted U shape. Accordingly, the door portion 41 consists of the first door portion 41a and the second door portion 41b which are configured to open in the same manner as double doors along the side surface portion 45 and the third door portion 41c which is configured to be rotatable to the opposite side of the side surface portion 45. An ornament 43 is disposed on the surface of the airbag cover 4 comprising the third door portion 41c.

In the event of an emergency (in which the ECU detects or predicts a crash or abrupt deceleration of a vehicle) the airbag apparatus provided with the airbag cover 4 causes the inflator 2 to supply gas to the airbag 1. As the airbag 1 inflates, it presses against the rear face of the airbag cover 4, causing the airbag cover 4 to split open along the tear line 44. As the airbag cover 4 splits, the first door portion 41a, the second door portion 41b, and the third door portion 41c to rotate (e.g., open outward) about portions where no tear line 44 is formed as hinge portions 46a, 46b, and 46c, respectively. Accordingly, as shown in FIG. 2(A), the first door portion 41a and the second door portion 41b open in the same manner as double doors along the side surface portion 45, while the third door portion 41c rotates to the opposite side of the side surface portion 45 together with the ornament 43. The first door portion 41a, the second door portion 41b, and the third door portion 41c are configured to be not able to rotate to the side of the side surface portion 45, but deploy in a substantially T shape. Preferably, the first door portion 41a and the second door portion 41b, when rotating, do not go beyond a line T passing through the top of the airbag cover 4. For convenience of description, the airbag 1 is indicated by dotted lines and the illustration of the inflator 2 is omitted in FIG. 2(A).

As shown in FIG. 2(B) depicting a rear view of the airbag 1 as inflated and deployed, the vent hole 11 is disposed along the side surface portion 45 of the airbag cover 4. The vent hole 11 reduces the inner pressure of the airbag 1 as well as mitigates an impact on an occupant. The conditions for the location, size, quantity, or the like of the vent hole 11 are determined by the conditions for the shape, capacity, or the like of the airbag 1 to be used. For a driver side airbag apparatus, there may be a need to form the vent hole 11 in a space encompassed by the rim 51, the hub 52, and the spoke 53 of the steering wheel 5. Consequently, when the airbag cover 4 splits open to cause the door portion 41 to rotate, an airbag cover 4 according to an exemplary embodiment prevents the rotating door portion 41 from blocking the space encompassed by the steering wheel 5. Although three vent holes 11 are formed in FIG. 2(B) as an example, according to other exemplary embodiments, one, two, or four or more vent holes 11 may be formed.

Further, when in an opened position, the door portion 41 of the airbag cover 4 does not extend beyond the side surface portion 45, thereby allowing a greater flexibility in the design and placement of the vent holes 11 in an airbag 1.

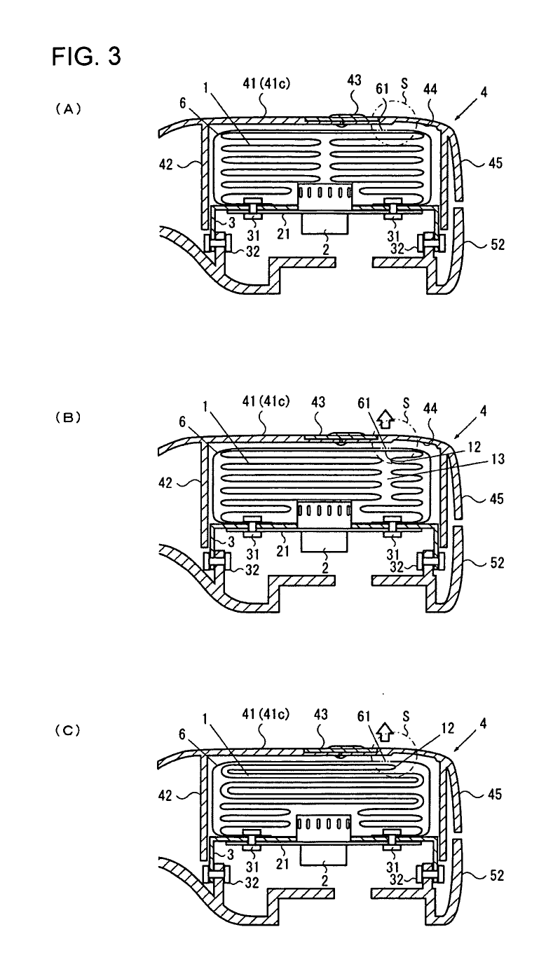

FIG. 3 is a sectional view showing an airbag apparatus according to several other exemplary embodiments. The reference numerals and symbols in these figures refer to the same components as those with the same reference numerals and symbols in FIG. 1, and repeated descriptions of the same components are omitted.

According to one exemplary embodiment, shown in FIG. 3(A), the predetermined fracture portion 61 of the wrapping component 6 is disposed at a position S close to a portion where the door portion 41 begins to split open. The position S close to a portion where the door portion 41 begins to split open refers to, for example, a portion enclosed by dashed-dotted lines in FIG. 3(A) and, more specifically, a portion close to a contact point (upper portion of the ornament 43) among the first door portion 41a, the second door portion 41b, and the third door portion 41c. Pressing against this portion allows the airbag cover 4 to effectively split open into the first door portion 41a, the second door portion 41b, and the third door portion 41c. The airbag 1 begins to inflate and deploy when the wrapping component 6 splits open starting at the predetermined fracture point 61. Accordingly, making the predetermined fracture portion 61 coincident with the portion where the door portion 41 begins to split open allows the airbag cover 4 to split open promptly and smoothly, thereby allowing the airbag 1 to more effectively inflate and deploy.

According to another exemplary embodiment, shown in FIG. 3(B), the airbag 1 may be folded in such a manner that the end portion 12 of the airbag 1 is disposed at the position S close to a portion where the door portion 41 begins to split open. The end portion 12 of the airbag 1 refers to a portion on which a force pressing against the rear face of the airbag cover 4 at the time of inflation of the airbag 1 tends to initially act. For example, as shown in the second example of modifications, in the case where the airbag 1 is inwardly folded, the end portion 12 of the airbag 1a is the portion located immediately above a communicating portion 13. Disposing the end portion 12 immediately below the position S allows the airbag cover 4 to split open promptly and smoothly, thereby allowing the airbag 1 to more effectively inflate and deploy. If an inflation force of the end portion 12 is strong enough to allow the airbag cover 4 to split open promptly and smoothly, the predetermined fracture portion 61 of the wrapping component 6 may be disposed away from the position S.

According to another exemplary embodiment, shown in FIG. 3(C), the end of the airbag 1 may be accordion-folded. In the case where the airbag 1 is accordion-folded, the end portion 12 of the airbag 1 is a portion on which a force pressing against the rear face of the airbag cover 4 tends to initially act. The way in which the airbag 1 is folded as shown in FIGS. 3(B) and 3(C) is given just as an example, and roll folding or a combination of inward folding and accordion folding may be used. Also, inward folding, accordion folding, or roll folding may be followed by vertical folding for reduction of volume.

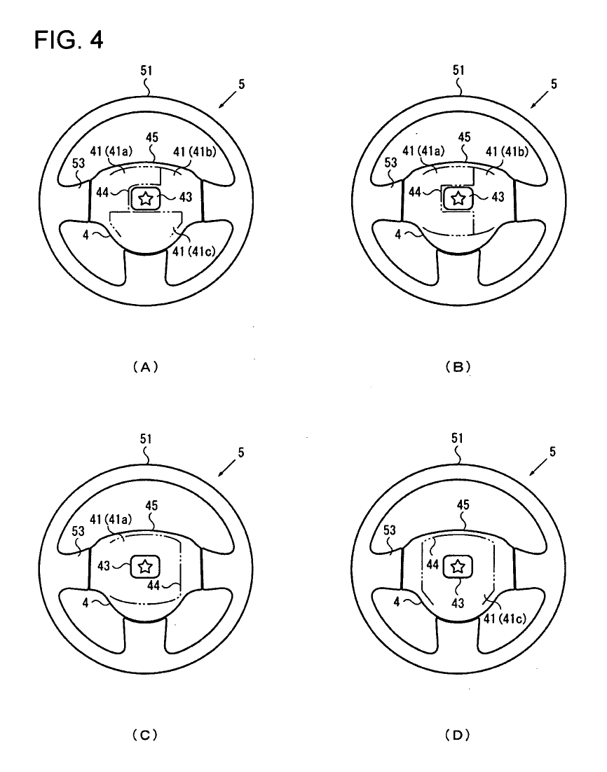

According to another exemplary embodiment, shown in FIG. 4(A), the door portion 41 includes the first door portion 41a, the second door portion 41b, and the third door portion 41c, wherein the ornament 43 such as an emblem is disposed on the second door portion 41b. The tear line 44 has a substantially T shape with the vertical section of the T shape offset or staggered (e.g., formed in the shape of a crank). This arrangement also prevents the door portion 41 from rotating to the side of the side surface portion 45. The ornament 43 may be disposed on the first door portion 41a, instead of the second door portion 41b.

According to another exemplary embodiment, shown in FIG. 4(B), the door portion 41 includes the first door portion 41a and the second door portion 41b, wherein the ornament 43 is disposed on the second door portion 41b. The tear line 44 is formed in a substantially H shape, whose vertical section has a convex portion formed therein. This arrangement also prevents the door portion 41 from rotating to the side of the side surface portion 45. The ornament 43 may be disposed on the first door portion 41a instead of the second door portion 41b.

According to another exemplary embodiment, shown in FIG. 4(C), the door portion 41 includes the first door portion 41a only, wherein the ornament 43 is disposed on the first door portion 41a. The tear line 44 is formed in a substantially inverted C shape. This arrangement also prevents the door portion 41 from rotating to the side of the side surface portion 45. The door portion 41 may also rotate the opposite way (e.g., include the second door portion 41b only).

According to another exemplary embodiment, shown in FIG. 4(D), the door portion 41 includes the third door portion 41c only, wherein the ornament 43 is disposed on the third door portion 41c. The tear line 44 is formed in a substantially inverted U shape. This arrangement also prevents the door portion 41 from rotating to the side of the side surface portion 45.

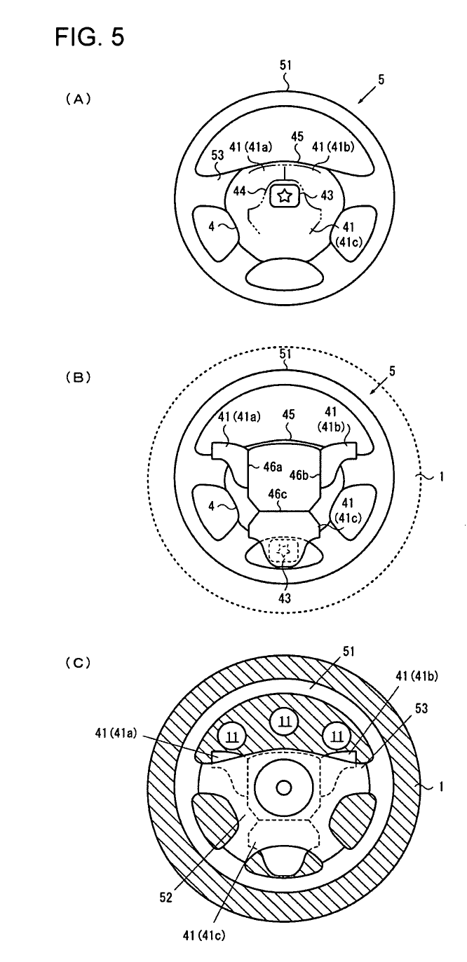

FIG. 5 is a diagram showing an airbag apparatus according to another exemplary embodiment. The reference numerals and symbols in these figures refer to the same components as those with the same reference numerals and symbols in FIG. 1, and repeated descriptions of the same components are omitted.

In the second embodiment shown in FIGS. 5(A) to 5(C), the steering wheel 5 has a different shape. As shown in FIG. 5(A), the steering wheel 5 has four spokes 53. The airbag cover 4 and the airbag apparatus can be utilized with a steering wheel 5 having such a shape.

Accordingly, as shown in FIG. 5(A), the tear line 44 of a predetermined shape is formed at the rear face of the airbag cover 4. The tear line 44 allows the cover 4 to split open into the door portion 41 (the first door portion 41a, the second door portion 41b, and the third door portion 41c).

In an emergency, the airbag cover 4 splits open along the tear line 44. Then, the first door portion 41a, the second door portion 41b, and the third door portion 41c rotate about the hinge portions 46a, 46b, and 46c. The first door portion 41a and the second door portion 41b opens in the same manner as double doors along the side surface portion 45, and the third door portion 41c rotates to the opposite side of the side surface portion 45 together with the ornament 43, as shown in FIG. 5(B).

Accordingly, when the airbag cover 4 splits open, the rotating door portion 41 of the airbag cover 4 does not block a space enclosed by the steering wheel 5. This allows a greater flexibility in design of the vent hole 11 to be formed in an airbag 1, allowing the vent hole to be placed anywhere in the space encompassed by the rim 51, the hub 52, and the spoke 53 of the steering wheel 5. Although three vent holes 11 are formed in FIG. 5(C) as an example, according to other exemplary embodiments, one, two, or four or more vent holes 11 may be formed.

The priority application, Japanese Patent Application No. 2009-026069, filed Feb. 6, 2009, including the specification, drawings, claims and abstract, is incorporated herein by reference in its entirety.

The present invention is not limited to the foregoing embodiments. Various modifications are conceivable within the scope of the present invention, including application to various types of airbag apparatuses and their airbag covers, such as a passenger side airbag apparatus, a side airbag apparatus, a curtain airbag apparatus, a knee airbag apparatus, and a pedestrian protective airbag apparatus, if these airbag apparatuses have vent holes formed along the side surface portion of the airbag cover.

The construction and arrangements of the airbag apparatus, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. An airbag cover for concealing an airbag, the cover comprising a door portion and wherein, in the event of an emergency, the door portion splits open for releasing the airbag, wherein the airbag has a vent hole that can release a gas supplied to an inside of the airbag and wherein the vent hole is disposed along a side surface portion of the airbag cover; and wherein the door portion is configured so as not to rotate to the side of the side surface portion.

2. The airbag cover according to claim 1, wherein the door portion is configured to open by rotating in the same manner as double doors along the side surface portion.

3. The airbag cover according to claim 2, wherein the door portion has an ornament to be disposed on the surface of the airbag cover, and the ornament rotates together with the door portion.

4. The airbag cover according to claim 1, wherein the door portion comprises a first door portion and a second door portion which are configured to open in the same manner as double doors along the side surface portion and a third door portion which is configured to be rotatable to the opposite side of the side surface portion, wherein the third door portion has an ornament to be disposed on the surface of the airbag cover.

5. The airbag cover according to claim 1, wherein the airbag cover is a driver side airbag cover disposed in a hub of a steering wheel.

6. An airbag apparatus comprising:
an airbag that is normally in a folded state and inflates and deploys in the event of an emergency;
an inflator that supplies gas to the airbag;
a retainer that houses the airbag; and
an airbag cover that normally conceals the airbag and, in the event of an emergency, splits open a door portion thereof for releasing the airbag into a passenger compartment of a vehicle,
wherein the airbag has a vent hole that can release the gas supplied to the airbag and wherein the vent hole is disposed along a side surface portion of the airbag cover; and wherein the door portion is configured so as not to rotate to the side of the side surface portion.

7. The airbag apparatus according to claim 6, wherein the airbag has a wrapping component that normally retains the shape of the airbag and has a predetermined fracture portion formed therein which, in the event of an emergency, fractures for allowing the airbag to be released, and the predetermined fracture portion is disposed in the vicinity of a portion where the door portion begins to split open.

8. The airbag apparatus according to claim 6, wherein the airbag is folded in such a manner that its end is disposed in the vicinity of a portion where the door portion begins to split open.

9. The airbag apparatus according to claim 6, wherein the door portion comprises a first door portion and a second door portion which are configured to open in the same manner as double doors along the side surface portion and a third door portion which is configured to be rotatable to the opposite side of the side surface portion, wherein the third door portion has an ornament to be disposed on the surface of the airbag cover.

10. The airbag apparatus according to claim 6, wherein the door portion is configured to open by rotating in the same manner as double doors along the side surface portion.

11. The airbag apparatus according to claim 10, wherein the door portion has an ornament to be disposed on the surface of the airbag cover, and the ornament rotates together with the door portion.
